(19) United States
(12) Patent Application Publication
(10) Pub. No.: US 2023/0177394 A1
(43) Pub. Date: Jun. 8, 2023

(54) METHOD OF GENERATING TRAINING DATA OF MANIPULATOR ROBOT AND APPARATUS PERFORMING THE SAME

(71) Applicant: ELECTRONICS AND TELECOMMUNICATIONS RESEARCH INSTITUTE, Daejeon (KR)

(72) Inventor: Hyonyoung HAN, Daejeon (KR)

(21) Appl. No.: 17/989,810

(22) Filed: Nov. 18, 2022

(30) Foreign Application Priority Data
Dec. 7, 2021 (KR) 10-2021-0173930
Oct. 13, 2022 (KR) 10-2022-0131604

(51) Int. Cl. G06N 20/00

(52) U.S. Cl. CPC G06N 20/00

(57) ABSTRACT

Provided is a method of generating training data of a manipulator robot and an apparatus performing the method. The method includes obtaining external appearance information of the plurality of components included in the training data from model information of the product and generating synthetic data in which position information of the component is labeled on a multi-angle image of the plurality of components, assembly information of the plurality of components, and assembly operation information of the plurality of components of the robot included in the training data based on the external appearance information.

### CROSS-REFERENCE TO RELATED APPLICATIONS

This application claims the benefit of Korean Patent Application No. 10-2021-0173930 filed on Dec. 7, 2021, and Korean Patent Application No. 10-2022-0131604 filed on Oct. 13, 2022, in the Korean Intellectual Property Office, the entire disclosure of which is incorporated herein by reference for all purposes.

### BACKGROUND

### 1. Field of the Invention

One or more embodiments relate to a method of generating training data of a manipulator robot and an apparatus for performing the method.

### 2. Description of Related Art

A manipulator robot currently used in factories and workshops only performs specified tasks. In order to transport and assemble a certain product or object, a skilled operator must manually teach the product-specific moving point of the manipulator and perform the teaching directly each time a new product is introduced. Because the factory work has to be stopped during these preparatory work hours, there is a great loss of operation rate at the factory. To solve this problem, an artificial intelligence (AI) image processing technology, an AI task planning technology, and an AI operation planning technology are being developed. The AI technology is divided into a stage of pre-training and a stage of performing real-time technology. In the training stage, a model is generated by training based on information appropriate to each task situation collected in advance. In the performing stage, a result is obtained by applying real-time data to the model generated in the training stage. In order to develop each AI technology, the training stage must be required, and prior learning and task information suitable for each technology are required for training.

The above description is information the inventor(s) acquired during the course of conceiving the present disclosure, or already possessed at the time, and is not necessarily art publicly known before the present application was filed.

### SUMMARY

In the training stage, prior learning and task information suitable for each technology are required, and this information must be generated by artificial intelligence (AI) technicians directly for the technology development. New tasks require skilled manipulator operators or AI technicians. Accordingly, in order to apply the AI technology to improve the operation rate of factory facilities, an automated technology that minimizes tasks done manually by skilled operators such as generating training data may be required.

Embodiments provide a technology for generating training data for training a manipulator robot.

Embodiments provide a technology for training a manipulator robot based on training data.

However, the technical aspects are not limited to the aforementioned aspects, and other technical aspects may be present.

Additional aspects of embodiments will be set forth in part in the description which follows and, in part, will be apparent from the description, or may be learned by practice of the disclosure.

According to embodiments, a method of generating training data of a manipulator robot that generates a product by assembling a plurality of components includes obtaining external appearance information of the plurality of components included in the training data from model information of the product and generating synthetic data in which position information of the plurality of components is labeled on a multi-angle image of the plurality of components, assembly information of the plurality of components, and assembly operation information of the plurality of components of the robot included in the training data based on the external appearance information.

The method may further include training the robot based on at least one of the external appearance information, the synthetic data, the assembly information, and the assembly operation information included in the training data.

The method may further include mapping the external appearance information, the synthetic data, the assembly information, and the assembly operation information to a name of the product obtained from the model information of the product and storing a mapped name.

The external appearance information of the plurality of components may include size information of the plurality of components and type information of the plurality of components.

The generating may include generating the synthetic data based on assembly order information included in the assembly operation information and the external appearance information.

The generating may include generating the assembly operation information based on the assembly information and the external appearance information, and the assembly operation information may include at least one of assembly scheme information, assembly start position information, and assembly direction information of the plurality of components.

The training of the robot may include training the robot to identify the plurality of components from an image of the product based on at least one of the external appearance information and the synthetic data. The training of the robot may include training an assembly plan for the product to the robot based on the assembly information and the assembly operation information.

According to embodiments, an apparatus for generating training data of a manipulator robot that generates a product by assembling a plurality of components includes a memory configured to store instructions and a processor electrically connected to the memory and configured to execute the instructions, and when the instructions are executed by the processor, the processor is configured to perform a plurality of operations, and the plurality of operations may include obtaining external appearance information of the plurality of components included in the training data from model information of the product and generating synthetic data in which position information of the plurality of components is labeled on a multi-angle image of the plurality of components, assembly information of the plurality of components, and assembly operation information of the plurality of components of the robot included in the training data based on the external appearance information.

The plurality of operations may further include training the robot based on at least one of the external appearance information, the synthetic data, the assembly information, and the assembly operation information included in the training data.

The plurality of operations may further include mapping the external appearance information, the synthetic data, the assembly information, and the assembly operation information to a name of the product obtained from the model information of the product and storing a mapped name.

The external appearance information of the plurality of components may include size information of the plurality of components and type information of the plurality of components.

The generating may include generating the synthetic data based on assembly order information included in the assembly operation information and the external appearance information.

The generating may include generating the assembly operation information based on the assembly information and the external appearance information, and the assembly operation information may include at least one of assembly scheme information, assembly start position information, and assembly direction information of the plurality of components.

The training of the robot may include training the robot to identify the plurality of components from an image of the product based on at least one of the external appearance information and the synthetic data.

The training of the robot may include training an assembly plan for the product to the robot based on the assembly information and the assembly operation information.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating an apparatus according to an embodiment;

FIG. 2A is a diagram illustrating a basic information generation module according to an embodiment;

FIG. 2B is a diagram illustrating an example of an output of a basic information generation module according to an embodiment;

FIG. 3A is a diagram illustrating an image information generation module according to an embodiment;

FIG. 3B is a diagram illustrating an example of an output of an image information generation module according to an embodiment;

FIG. 4A is a diagram illustrating a task information generation module according to an embodiment;

FIG. 4B is a diagram illustrating an example of an output of a task information generation module according to an embodiment;

FIG. 5A is a diagram illustrating an operation information generation module according to an embodiment;

FIG. 5B is a diagram illustrating an example of an output of an operation information generation module according to an embodiment; and

FIG. 6 is a diagram illustrating another example of an apparatus according to an embodiment.

### DETAILED DESCRIPTION

The following detailed structural or functional description is provided as an example only and various alterations and modifications may be made to the examples. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one embodiment, the module may be implemented in a form of an application-specific integrated circuit (ASIC).

Hereinafter, examples will be described in detail with reference to the accompanying drawings. When describing the embodiments with reference to the accompanying drawings, like reference numerals refer to like elements and a repeated description related thereto will be omitted.

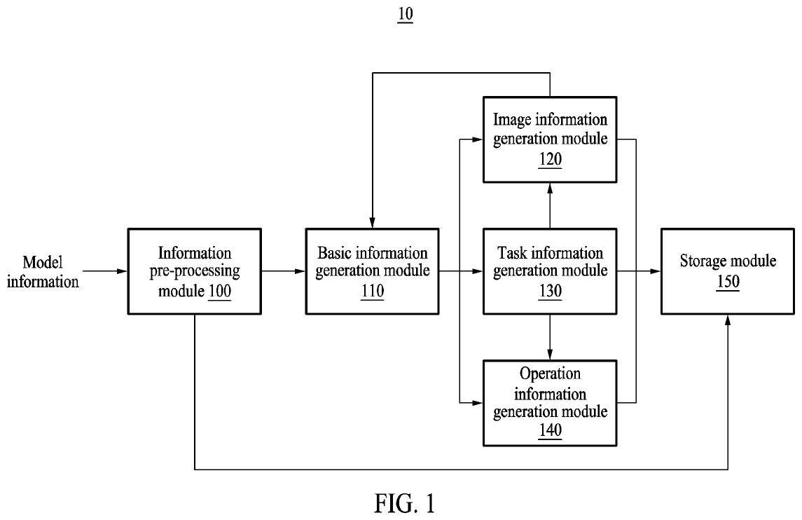

FIG. 1 is a block diagram illustrating an apparatus according to an embodiment.

Referring to FIG. 1, according to an embodiment, an apparatus 10 may include an information pre-processing module 100, a basic information generation module 110, an image information generation module 120, a task information generation module 130, and an operation information generation module 140, and a storage module 150. The apparatus 10 may generate training data of a manipulator robot that generates a product by assembling a plurality of components by using components (e.g., the information pre-processing module 100, the basic information generation module 110, the image information generation module 120, the task information generation module 130, the operation information generation module 140, and the storage module 150.)

According to an embodiment, the information pre-processing module 100 may map external appearance information, synthetic data, assembly information, and assembly operation information to a name of a product obtained from model information of the product. The information pre-processing module 100 may transmit a mapped name to the storage module 150 to store the mapped name. The model information may be information about the design of the product (e.g., computer-aided diagnosis (CAD) information.)

According to an embodiment, the basic information generation module 110 may obtain the external appearance information of a plurality of components from the model information of the product. The external appearance information of the component may include size information of the component and type information of the component.

According to an embodiment, the image information generation module 120 may generate synthetic data in which position information of the component is labeled on a multi-angle image of the component based on the external appearance information. The image information generation module 120 may generate the synthetic data based on assembly order information included in the assembly operation information and the external appearance information.

According to an embodiment, the task information generation module 130 may generate assembly information of the component. The assembly information may include information about an assembly structure and an assembly order. The task information generation module 130 may transmit the assembly order information to the image information generation module 120 and transmit the assembly information to the operation information generation module 140.

According to an embodiment, the operation information generation module 140 may generate assembly operation information for the component of the robot. The operation information generation module 140 may generate the assembly operation information based on the assembly information and the external appearance information. The assembly operation information may include at least one of assembly scheme information, assembly start position information, and assembly direction information of the component.

According to an embodiment, the storage module 150 may store information generated by the information pre-processing module 100, the basic information generation module 110, the image information generation module 120, the task information generation module 130, and the operation information generation module 140. The storage module 150 may classify information generated by other modules based on a mapped name and store classified information.

According to an embodiment, the apparatus 10 may train the robot based on at least one of external appearance information, synthetic data, assembly information, and assembly operation information included in the training data. The apparatus 10 may train the robot to identify the component from an image of the product based on at least one of the external appearance information and the synthetic data. The apparatus 10 may train an assembly plan for the product to the robot based on the assembly information and the assembly operation information.

According to an embodiment, the apparatus 10 may train the robot to identify the component from an image of the product based on at least one of size information included in the external appearance information and synthetic data.

According to an embodiment, the apparatus 10 may train the robot to identify a position of the component from an image of the product based on at least one of component type information included in the external appearance information and synthetic data.

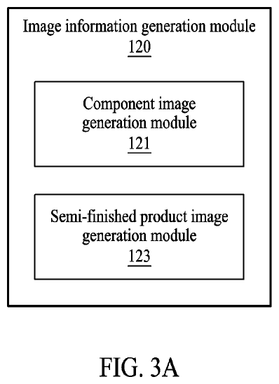

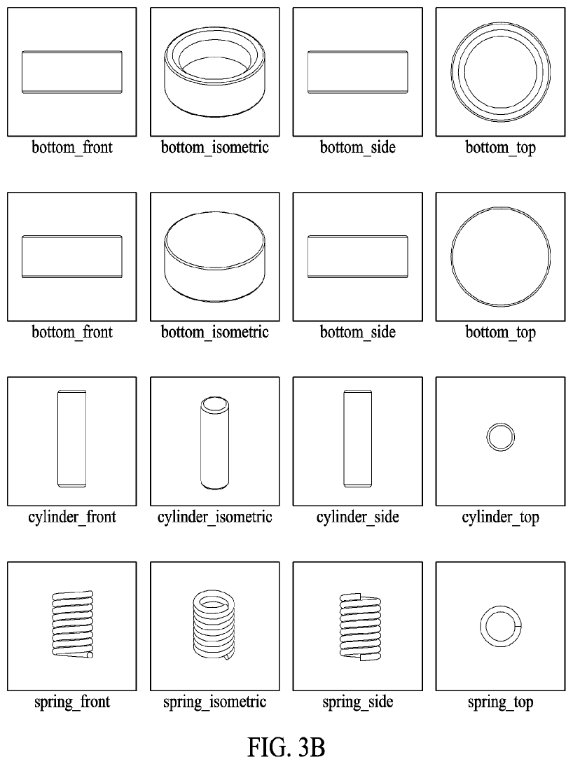

According to an embodiment, the apparatus 10 may train the robot to verify an assembly order based on second synthetic data to be described later with reference to FIG. 3A. The apparatus 10 may train an assembly plan based on an artificial intelligence (AI) planning to the robot based on assembly information.

According to an embodiment, when the robot trains the component assembly operation of the product, the apparatus 10 may use the assembly information and the assembly operation information as at least one of a target of the operation training, a policy for performing the operation, and a reward.

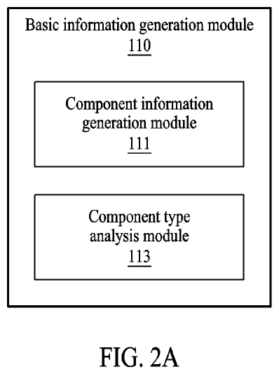

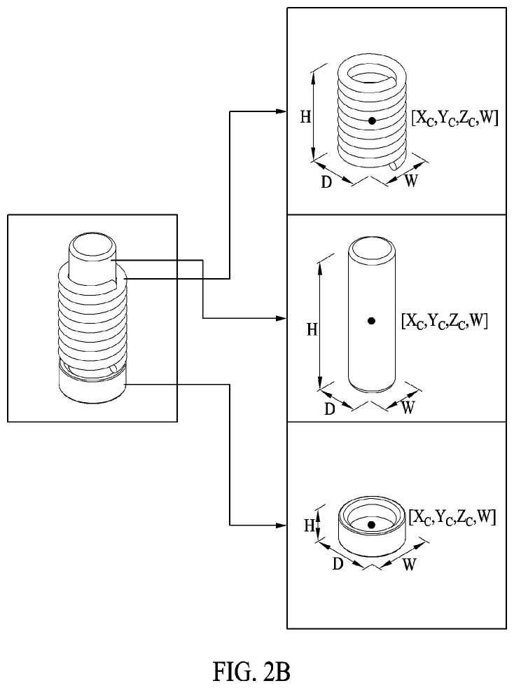

FIG. 2A is a diagram illustrating a basic information generation module according to an embodiment and FIG. 2B is a diagram illustrating an example of an output of a basic information generation module according to an embodiment.

Referring to FIGS. 2A and 2B, according to an embodiment, the basic information generation module 110 may obtain external appearance information of a plurality of components from model information of a product. The external appearance information of the component may include size information of the component and type information of the component.

According to an embodiment, the basic information generation module 110 may include a component information generation module 111 and a component type analysis module 113. The component information generation module 111 may extract size information (e.g., width, length, height, etc.) of the component from model information. The component type analysis module 113 may perform image processing on a multi-angle image received from the image information generation module 120 based on the model information. The component type analysis module 113 may generate a result of performing the image processing and type information of the component (e.g., sphere, cylinder, cube, cone, etc.)

For example, in FIG. 2B, the basic information generation module 110 may obtain external appearance information on the right side from the model information on the left side. The external appearance information may include size information (e.g., H, D, W) of three components included in the product and type information (e.g., coil, cylinder, etc.) of the component.

FIG. 3A is a diagram illustrating an image information generation module according to an embodiment and FIG. 3B is a diagram illustrating an example of an output of an image information generation module according to an embodiment.

Referring to FIGS. 3A and 3B, according to an embodiment, the image information generation module 120 may generate synthetic data in which position information of the component is labeled on a multi-angle image of the component based on external appearance information. The image information generation module 120 may generate the synthetic data based on assembly order information included in the assembly operation information and the external appearance information.

According to an embodiment, the image information generation module 120 may include a component image generation module 121 and a semi-finished product image generation module 123. The component image generation module 121 may generate first synthetic data in which position information of the component is labeled on a multi-angle image of the component for each component. The semi-finished product image generation module 123 may generate second synthetic data in which position information of the semi-finished product is labeled on a multi-angle image of the semi-finished product for each semi-finished product.

For example, in FIG. 3B, the image information generation module 120 may generate an image of four angles (e.g., front, isometric, side, and top) for four components.

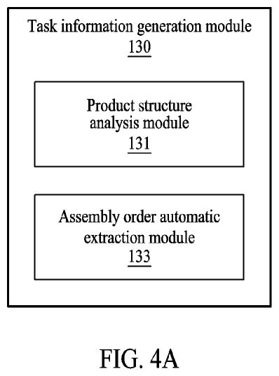

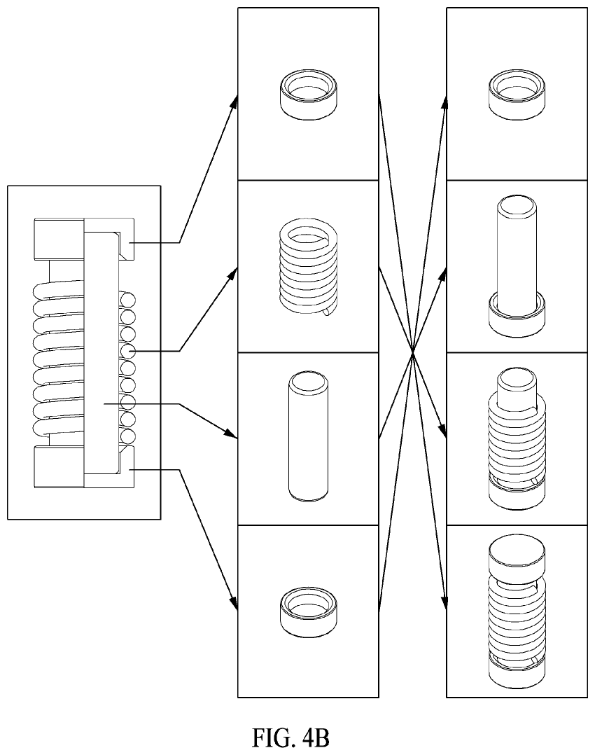

FIG. 4A is a diagram illustrating a task information generation module according to an embodiment and FIG. 4B is a diagram illustrating an example of an output of a task information generation module according to an embodiment.

Referring to FIGS. 4A and 4B, according to an embodiment, the task information generation module 130 may generate assembly information of the component. The assembly information may include information about an assembly structure and an assembly order. The operation information generation module 130 may transmit assembly order information to the image information generation module 120 and transmit assembly information to the operation information generation module 140.

According to an embodiment, the task information generation module 130 may include a product structure analysis module 131 and an assembly order automatic extraction module 133. The product structure analysis module 131 may generate information about an assembly structure of the component based on external appearance information and model information. The assembly order automatic extraction module 133 may analyze a coupling structure between a plurality of products included in the product based on the external appearance information, the model information, and the information about the assembly structure of the component. The assembly order automatic extraction module 133 may generate information about an analysis result and an assembly order.

For example, in FIG. 4B, the task information generation module 130 may analyze a coupling structure between four components included in the product on the left side and assign any one of first to fourth orders to each component. The task information generation module 130 may generate an image of four stages sequentially assembled according to the first to fourth orders.

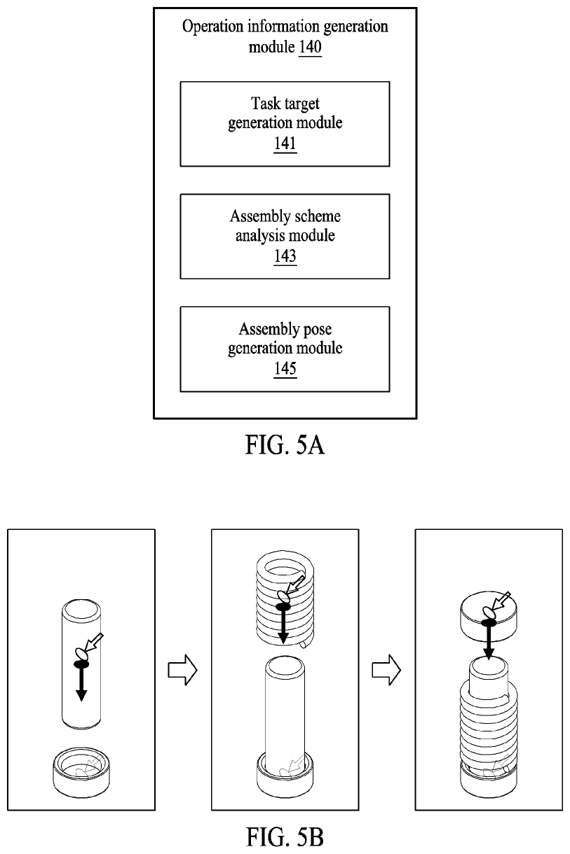

FIG. 5A is a diagram illustrating an operation information generation module according to an embodiment and FIG. 5B is a diagram illustrating an example of an output of an operation information generation module according to an embodiment.

Referring to FIGS. 5A and 5B, according to an embodiment, the operation information generation module 140 may generate assembly operation information for the component of the robot. The operation information generation module 140 may generate the assembly operation information based on the assembly information and the external appearance information. The assembly operation information may include at least one of assembly scheme information, assembly start position information, and assembly direction information of the component.

According to an embodiment, the operation information generation module 140 may include a task target generation module 141, an assembly scheme analysis module 143, and an assembly pose generation module 145. The task target generation to module 141 may extract target position information of each component on the product. The assembly scheme analysis module 143 may generate assembly scheme information (e.g., peg-in-hole, snap-fit and screw-in, etc.) for each assembly step based on assembly information generated by the task information generation module 130 and external appearance information generated by the basic information generation module 110. The assembly pose generation module 145 may generate assembly start position information and assembly direction information of a plurality of components for each step according to an assembly order.

For example, in FIG. 5B, the operation information generation module 140 may generate the assembly start position information and the assembly direction information of the component assembled in three stages according to the assembly order between the plurality of components.

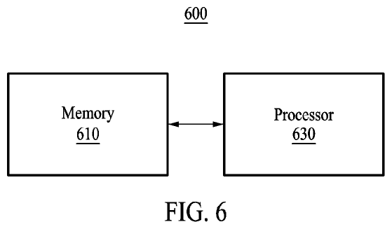

FIG. 6 is a diagram illustrating another example of an apparatus according to an embodiment.

Referring to FIG. 6, according to an embodiment, an apparatus 600 may include a memory 610 and a processor 630.

According to various embodiments, the memory 610 may store instructions (e.g., a program) executable by the processor 630. For example, the instructions may include instructions for performing an operation of the processor 630 and/or an operation of each component of the processor 630.

According to embodiments, the memory 610 may be implemented as a volatile memory device or a non-volatile memory device. The volatile memory device may be implemented as dynamic random-access memory (DRAM), static random-access memory (SRAM), thyristor RAM (T-RAM), zero capacitor RAM (Z-RAM), or twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM(CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, and/or insulator resistance change memory.

According to various embodiments, the processor 630 may execute computer- readable code (e.g., software) stored in the memory 610 and instructions triggered by the processor 630. The processor 630 may be a hardware-implemented data processing device having a circuit that is physically structured to execute desired operations. The desired operations may include code or instructions included in a program. For example, the hardware-implemented data processing device may include a microprocessor, a CPU, a processor core, a multi-core processor, a multiprocessor, an application-specific integrated circuit (ASIC), and a field-programmable gate array (FPGA.)

According to various embodiments, operations performed by the processor 630 may be substantially the same as the operations performed by the apparatus 100 described with reference to FIGS. 1 to 5B. Each component (e.g., the information pre-processing module 100, the basic information generation module 110, the image information generation module 120, the task information generation module 130, the operation information generation module 140, and the storage module 150) of the apparatus 100 described with reference in FIGS. 1 to 5B may be executed by the processor 630. Accordingly, further description thereof is not repeated herein.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more of general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of generating training data of a manipulator robot that generates a product by assembling a plurality of components, the method comprising:
obtaining external appearance information of the plurality of components comprised in the training data from model information of the product; and
generating synthetic data in which position information of the plurality of components is labeled on a multi-angle image of the plurality of components, assembly information of the plurality of components, and assembly operation information of the plurality of components of the robot comprised in the training data based on the external appearance information.

2. The method of claim 1, further comprising:
training the robot based on at least one of the external appearance information, the synthetic data, the assembly information, and the assembly operation information comprised in the training data.

3. The method of claim 1, further comprising:
mapping the external appearance information, the synthetic data, the assembly information, and the assembly operation information to a name of the product obtained from the model information of the product; and
storing a mapped name.

4. The method of claim 1, wherein the external appearance information of the plurality of components comprises size information of the plurality of components and type information of the plurality of components.

5. The method of claim 1, wherein the generating comprises generating the synthetic data based on assembly order information comprised in the assembly operation information and the external appearance information.

6. The method of claim 1, wherein the generating comprises:
generating the assembly operation information based on the assembly information and the external appearance information, and
the assembly operation information comprises at least one of assembly scheme information, assembly start position information, and assembly direction information of the plurality of components.

7. The method of claim 2, wherein the training of the robot comprises training the robot to identify the plurality of components from an image of the product based on at least one of the external appearance information and the synthetic data.

8. The method of claim 2, wherein the training of the robot comprises training an assembly plan for the product to the robot based on the assembly information and the assembly operation information.

9. A non-transitory computer-readable storage medium storing instructions that, when executed by a processor, cause the processor to perform the method of claims 1.

10. An apparatus for generating training data of a manipulator robot that generates a product by assembling a plurality of components, the apparatus comprising:
a memory configured to store instructions; and
a processor electrically connected to the memory and configured to execute the instructions,
wherein, when the instructions are executed by the processor, the processor is configured to perform a plurality of operations, and
wherein the plurality of operations comprises:
obtaining external appearance information of the plurality of components comprised in the training data from model information of the product; and
generating synthetic data in which position information of the plurality of components is labeled on a multi-angle image of the plurality of components, assembly information of the plurality of components, and assembly operation information of the plurality of components of the robot comprised in the training data based on the external appearance information.

11. The apparatus of claim 10, wherein the plurality of operations further comprises training the robot based on at least one of the external appearance information, the synthetic data, the assembly information, and the assembly operation information comprised in the training data.

12. The apparatus of claim 10, wherein the plurality of operations further comprises:
mapping the external appearance information, the synthetic data, the assembly information, and the assembly operation information to a name of the product obtained from the model information of the product; and
storing a mapped name.

13. The apparatus of claim 10, wherein the external appearance information of the plurality of components comprises size information of the plurality of components and type information of the plurality of components.

14. The apparatus of claim 10, wherein the generating comprises generating the synthetic data based on assembly order information comprised in the assembly operation information and the external appearance information.

15. The apparatus of claim 10, wherein the generating comprises generating the assembly operation information based on the assembly information and the external appearance information,
wherein the assembly operation information comprises at least one of assembly scheme information, assembly start position information, and assembly direction information of the plurality of components.

16. The apparatus of claim 11, wherein the training of the robot comprises training the robot to identify the plurality of components from an image of the product based on at least one of the external appearance information and the synthetic data.

17. The apparatus of claim 11, wherein the training of the robot comprises training an assembly plan for the product to the robot based on the assembly information and the assembly operation information.
